(19) United States
(12) Patent Application Publication
(10) Pub. No.: US 2015/0199028 A1
(43) Pub. Date: Jul. 16, 2015

(54) KEYBOARD-CONTROLLED DEVELOPER MODE

(71) Applicants: Randall R. Spangler, San Jose, CA (US); Ryan Tabone, San Francisco, CA (US); William A. Drewry, Nashville, TN (US); Linus Michael Upson, Woodside, CA (US)

(72) Inventors: Randall R. Spangler, San Jose, CA (US); Ryan Tabone, San Francisco, CA (US); William A. Drewry, Nashville, TN (US); Linus Michael Upson, Woodside, CA (US)

(73) Assignee: GOOGLE INC., Mountain View, CA (US)

(21) Appl. No.: 13/326,176

(22) Filed: Dec. 14, 2011

(51) Int. Cl. G06F 9/06; G06F 9/44

(52) U.S. Cl. CPC G06F 3/0227; G06F 9/4401; G06F 8/70

(57) ABSTRACT

A computer-implemented method for controlling a developer mode of a computer is disclosed according to an aspect of the subject technology. The method comprises, during boot time of the computer, determining whether one or more keys on a keyboard corresponding to the developer mode are held down, and, if the one or more keys are held down, then setting a developer mode value within a lockable memory space to enable the developer mode.

### FIELD

The subject disclosure generally relates to computers, and, in particular, to developer modes in computers.

### BACKGROUND

A computer (e.g., a laptop) may operate in a normal mode, in which the computer runs verified code that is digitally signed by a trusted supplier (e.g., using a cryptographic key). The computer may also operate in a developer mode, in which the computer may run unverified, unsigned or user-signed code, allowing a developer to build and run its own code on the computer.

### SUMMARY

A computer-implemented method for controlling a developer mode of a computer is disclosed according to an aspect of the subject technology. The method comprises, during boot time of the computer, determining whether one or more keys on a keyboard corresponding to the developer mode are held down, and, if the one or more keys are held down, then setting a developer mode value within a lockable memory space to enable the developer mode.

A machine-readable medium is disclosed according to an aspect of the subject technology. The machine-readable medium comprises instructions stored therein, which when executed by a machine, cause the machine to perform operations for controlling a developer mode of a computer. The operations comprise, during boot time of the computer, determining whether a combination of keys on a keyboard corresponding to the developer mode are held down, and, if the combination of keys are held down, then setting a developer mode value within a lockable memory space to enable the developer mode.

A system for controlling a developer mode of a computer is disclosed according to an aspect of the subject technology. The system comprises one or more processors, and a machine-readable medium comprising instructions stored therein, which when executed by the one or more processors, cause the one or more processors to perform operations. The operations comprise, during boot time of the computer, determining whether one or more keys on a keyboard corresponding to the developer mode are held down, and, if the one or more keys are held down, then setting a developer mode value within a lockable memory space to enable the developer mode. The operations also comprise locking the lockable memory space until the computer is rebooted.

A computer-implemented method for controlling a developer mode of a computer is disclosed according to an aspect of the subject technology. The method comprises, during boot time of the computer, determining whether one or more keys on a keyboard corresponding to the developer mode are held down and, if the one or more keys are held down, then performing steps. The steps comprise displaying a message, receiving a message entered into the computer by a user, determining whether the received message matches the displayed message, and, if the received message matches the displayed message, then setting a developer mode value within a lockable memory space to enable the developer mode.

A machine-readable medium is disclosed according to an aspect of the subject technology. The machine-readable medium comprises instructions stored therein, which when executed by a machine, cause the machine to perform operations for controlling a developer mode of a computer. The operations comprise, during boot time of the computer, determining whether one or more keys on a keyboard corresponding to the developer mode are held down, and, if the one or more keys are held down, then performing steps. The steps comprise setting a request flag to request that the developer mode be enabled, rebooting the computer to a next boot cycle, and, during the next boot cycle and in response to the request, setting a developer mode value within a lockable memory space to enable the developer mode.

A computer-implemented method for recovering a computer is disclosed according to an aspect of the subject technology. The method comprises determining whether a developer mode value within a lockable memory space is set to enable a developer mode, and if the developer mode value is set to enable the developer mode, then setting the developer mode value within the lockable memory space to disable the develop mode. The method also comprises locking the lockable memory space, and booting the computer using a boot image.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a conceptual block diagram of a computer according to an aspect of the subject technology.

FIG. 2 shows a non-volatile memory according to an aspect of the subject technology.

FIG. 3 shows a process for enabling the developer mode according to an aspect of the subject technology.

FIG. 4 shows a recovery process according to an aspect of the subject technology.

FIG. 5A shows a processor that interfaces with a keyboard through an embedded controller according to an aspect of the subject technology.

FIG. 5B shows the processor interfacing with the keyboard through the embedded controller and a communication link that bypasses the embedded controller according to an aspect of the subject technology.

FIGS. 6A and 6B show a process for controlling the developer mode according to an aspect of the subject technology.

FIG. 7A shows a process for enabling the developer mode according to another aspect of the subject technology.

FIG. 7B shows a process for disabling the developer mode according to an aspect of the subject technology.

FIG. 7C shows a process for requesting that the developer mode be disabled according to an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A computer (e.g., a laptop) may operate in a normal mode, in which the computer runs verified code that is digitally signed by a trusted supplier (e.g., using a cryptographic key). The computer may also operate in a developer mode, in which the computer may run unverified, unsigned or user-signed code, allowing a developer to build and run its own code on the computer. The developer mode may do this by disabling certain security features of the computer that protect a normal user from security attacks, such as a verified boot process that verifies that code is from a trusted supplier before executing the code.

A developer may enable the developer mode by switching a physical switch on the computer. An advantage of using a physical switch to enable the developer mode is that the physical switch cannot be switched remotely. This prevents an unauthorized user from remotely enabling the developer mode to disable security features of the computer and hack into the computer. However, the physical switch requires additional components on the computer.

Various aspects of the subject technology provide a keyboard-controlled developer mode, which eliminates the need for the physical switch. In one aspect, a developer may enable the developer mode by holding down a specific key or a combination of keys on a keyboard at power on or while the computer is booting. In another aspect, a developer mode value that controls whether the computer is in the developer mode may be stored in a secure memory. The developer mode value may be locked in the secure memory after boot to prevent an attacker from setting the developer mode value to enable the developer mode. These and other aspects of the subject technology are described in greater detail below.

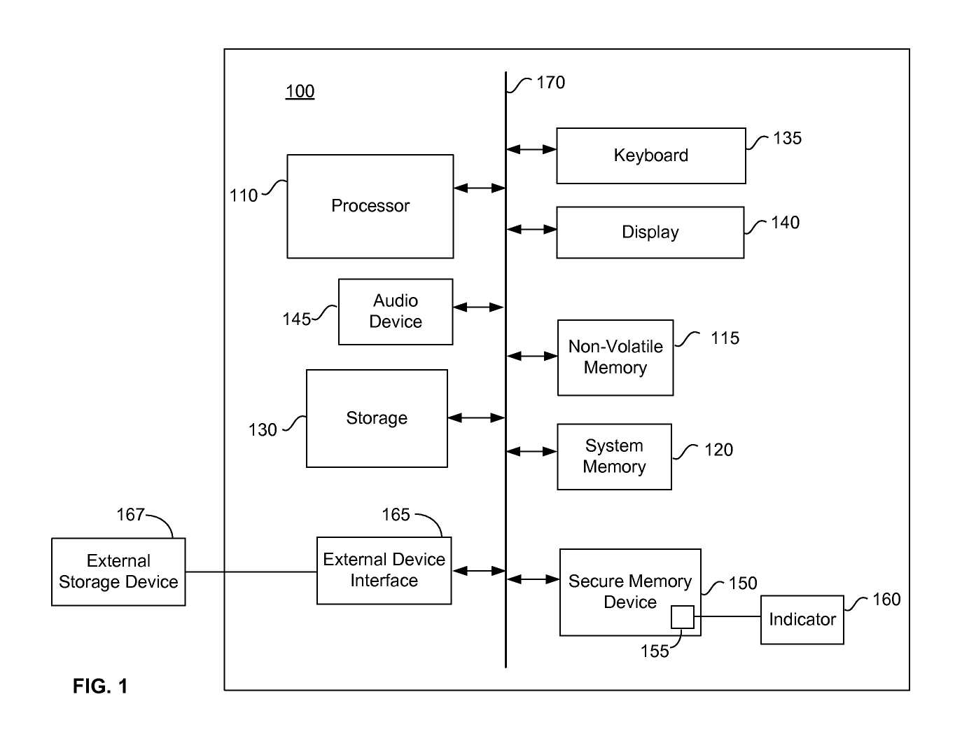

FIG. 1 shows a computer 100 according to an aspect of the subject technology. The computer may 100 be a laptop computer, a desktop computer, a tablet, a smart phone, or other type of computer. While the computer 100 is shown in one configuration in FIG. 1, it is to be understood that the computer may include additional, alternative and/or fewer devices.

In the example shown in FIG. 1, the computer 100 includes a processor 110, a non-volatile memory 115, a system memory 120, an internal storage device 130, a secure memory device 150, and a bus 170. The bus 170 collectively represents all system, peripheral, and chipset buses that communicatively connect the numerous devices of the computer 100. For instance, the bus 170 communicatively connects the processor 110 with the non-volatile memory 115, the system memory 120, the internal storage device 130 and the secure memory device 150. The processor 110 may retrieve instructions from one or more of these memories 115, 120, 130 and 150 and execute the instructions to implement processes according to various aspects of the subject technology. The processor 110 may comprise a single processor or a multi-core processor in different implementations.

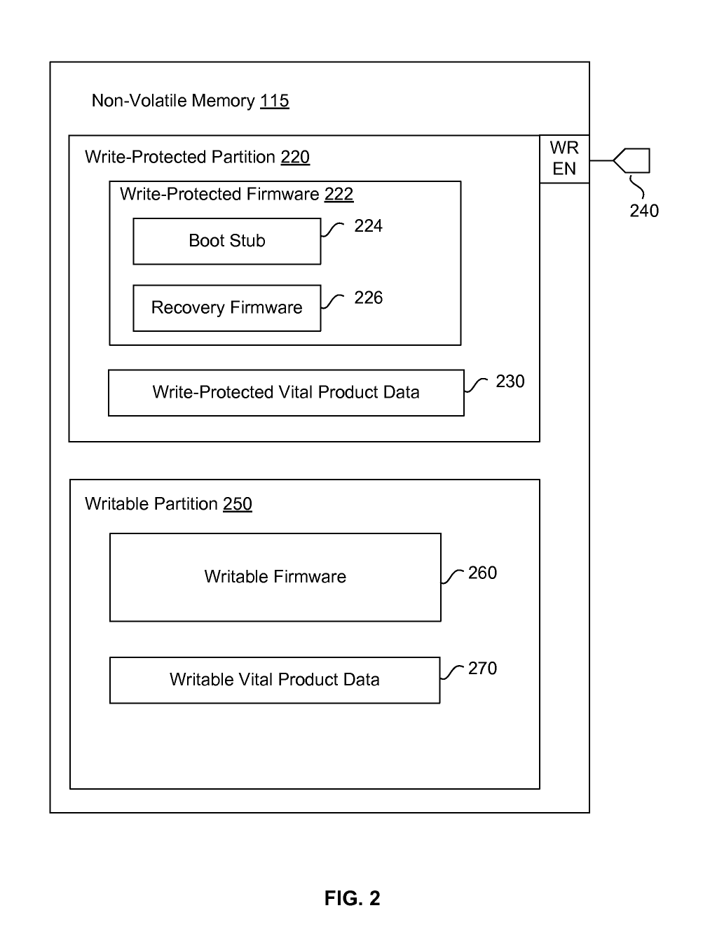

The non-volatile memory 115 may comprise an electrically erasable programmable read-only memory (EEPROM), an embedded multimedia card (e-MMC), a NOR Flash, a NAND Flash, battery-backed RAM, and/or other type of non-volatile memory. The non-volatile memory 115 may be used to store firmware for booting the computer 100 and vital product data providing information about the computer 100. The non-volatile memory 115 is discussed in greater detail below with reference to FIG. 2 according to an aspect of the subject technology.

The internal storage device 130 comprises a read-and-write memory that can store information when the computer 100 is turned off, such as a solid state drive, a magnetic disk drive, or an optical drive. The storage device 130 may be used to store an operating system (OS), programs, and/or files. The system memory 120 comprises a volatile read-and-write memory, such a random access memory. The system memory 120 may be used to store instructions and data that the processor 110 needs at runtime.

In one aspect, the secure memory device 150 is configured to securely store one or more values that are used to control certain operations of the computer 100. The secure memory device 150 may be implemented using a trusted platform module (TPM) chip or other memory chip that includes one or more lockable memory spaces (e.g., internal registers) for securely storing one or more values. The secure memory device 150 may comprise EEPROM, battery-back RAM or other type of memory capable of storing values across power cycles.

In one aspect, the secure memory device 150 stores a developer mode value in a lockable memory space 155 that controls whether the computer 100 is in the developer mode. For example, the developer mode value may be one when the developer mode is enabled and zero when the developer mode is disabled. In this aspect, the developer mode value may only be set to one to enable the developer mode when the lockable memory space 155 is unlocked, as explained further below. The lockable memory space 155 may store the developer mode value across power cycles so that the developer mode value persists across power cycles.

The computer 100 also includes a keyboard 135, a display 140, an audio device 145, an external device interface 165, and a light indicator 160. The keyboard 135 enables a user to communicate information and commands to the processor 110 by pressing keys on the keyboard 135. The display 140 enables the processor 110 to display information to the user, and may include a liquid crystal display (LCD) or other type of display. The audio device 145 enables the processor 110 to output sounds to audibly communicate with the user, and may include one or more speakers or other audio device.

The external device interface 165 enables the computer processor 110 to communicate with an external storage device 167 and/or other external device. For example, the external storage device 167 may be coupled to the external device interface 165 via a physical link (e.g., a universal serial bus (USB) link) and/or a wireless link (e.g., a WiFi wireless link, a Bluetooth link, etc.). The external storage device 167 may be a USB drive or a secure digital (SD) card, and the interface 165 may be a USB port or a SD card reader, respectively. In one aspect, the external device interface 165 may detect when the external storage device 167 is coupled to the interface (e.g., plugged into a USB port of the computer 100) and notify the processor 110 of the presence of the external storage device 167.

In one aspect, the secure memory device 150 is configured to activate the light indicator 160 when the developer mode value in the lockable memory space 155 is one to alert the user that the developer mode is enabled. For example, the indicator 160 may comprise an LED, and the secure memory device 150 may activate the LED by turning on the LED. In this example, the secure memory device 150 may turn on the LED by driving the LED via dedicated general purpose input output (GPIO) lines.

In one aspect, the secure memory device 150 may include hard-wired circuitry configured to activate the light indicator 160 based on the value of the developer mode value in the lockable memory space 155. For example, the hard-wired circuitry may activate the light indicator 160 (e.g., via dedicated GPIO lines) when the developer mode value in the lockable memory space 155 is one, indicating that the developer mode is enabled. The hard-wired circuitry may turn off the light indicator 160 when the developer mode value in the lockable memory space 155 is zero. This prevents an attacker without physical access to the internal circuitry of the computer 100 from switching off the light indicator 160 when the developer mode value is one. Thus, even if an attacker manages to enable the developer mode by setting the developer mode value to one, the light indicator 160 is activated to alert the user that the computer 100 is in the developer mode. In response to the alert, the user may take appropriate action, such as forcing the computer into recovery mode to restore the computer to a known and trusted state.

FIG. 2 is a conceptual block diagram of the non-volatile memory 115 according to an aspect of the subject technology. The non-volatile memory 115 comprises a write-protected partition 220 and a writable partition 250. The non-volatile memory 115 may be configured to allow the processor 110 to read content in the write-protected partition 220, but not to erase and rewrite content in the write-protected partition 220. The write-protected partition 220 may be used to protect system critical firmware (e.g., write-protected firmware) and data from being rewritten by an attacker. The non-volatile memory 115 may be configured to allow the processor 110 to read and write content in the writable partition 250. The writable partition 250 may be used to store content that may be updated (e.g., writable firmware), and/or generated during runtime (e.g., an event log).

In one aspect, the non-volatile memory 115 may include a write-enable pin 240 or write protection pin that controls whether content in the write-protected partition 220 can be rewritten. For example, the write-enable pin 240 may be pulled up to allow writes to the write-protected partition 220 and pulled down to prevent writes to the write-protected partition 220.

In this aspect, content (i.e., write-protected firmware) may be written to the write-protected partition 220 during manufacturing. Before the computer 100 is shipped from the manufacturer, the write-enable pin 240 or write protection pin may be set to prevent the content in the write-protected partition 220 from being rewritten (e.g., by an attacker). For example, the write-enable pin 240 may be pulled down by internal circuitry (not shown) in the computer 100 to prevent the content in the write-protected partition 220 from being rewritten. As a result, content in the write-protected partition 220 cannot be easily rewritten by an attacker without physical access to the internal circuitry of the computer 100. The write-protected partition 220 may be write-protected by another write-protection mechanism (e.g., depending on the type of non-volatile memory used). For example, the write-protected partition 220 may be implemented using a read only memory (ROM) chip.

The write-protected partition 220 may include write-protected firmware 222 and write-protected vital product data 230. The write-protected vital product data 230 may include machine-specific information that is to remain fixed, such as manufacturer of the computer 100, mother board serial number, MAC address, and/or other information. The write-protected firmware 222 may include a boot stub 224 and recovery firmware 226. The boot stub 224 may be configured to initiate a boot process of the computer 100 when executed by the processor 110 and the recovery firmware 226 may be configured to perform a recovery process when executed by the processor 110 to restore the computer 100 to a known and trusted state, as discussed further below.

The writable partition 250 may include writable firmware 260 and writable vital product data 270. The writable firmware 260 may be configured to complete the boot process when executed by the processor 110. The boot process may include detecting the devices in the computer 100 and running verification tests. The boot process may also include verifying that the OS is signed by a trusted supplier, loading the OS into the system memory 120 (e.g., RAM memory) when the OS is properly signed, and executing the OS. The writeable firmware 260 may be updated after shipment of the computer 100 by an auto-update program, for example, when an update to the writeable firmware 260 becomes available on a network.

In one aspect, the boot stub 224 may be configured to verify that the writable firmware 260 is signed by a trusted supplier (e.g., using a cryptographic key) before allowing the processor 110 to execute the writable firmware 260. If the boot stub 224 is unable to verify the writable firmware 260, then the boot stub 224 may direct to the processor 110 to execute the recovery firmware 226 to restore the computer 100 to a known and trusted state. The recovery process may include overwriting the rewritable firmware 260 in the non-volatile memory 115 with firmware signed by a trusted supplier from the external storage device 167.

The writable vital product data 270 may include vital product data that may be updated and/or vital product data that is generated after the computer 100 is shipped from the manufacturer. For example, the writable vital product data 270 may include the date and time that the computer 100 is first used by a user. This information may be used to determine whether the computer 100 is still under a warranty that runs from the first time the user uses the computer 100. The writable vital product data 270 may also include an event log for recording information about system-critical events that may occur during runtime, including the occurrence of events which caused or lead up to a catastrophic failure.

When the computer 100 is booted, the boot stub 224 and/or other firmware may check the developer mode value in the secure memory device 150, and operate the computer 100 in the normal mode or the developer mode based on whether the developer mode value is one or zero. For example, the boot stub 224 and/or other firmware may operate the computer 100 in the normal mode when the developer mode value is zero and operate the computer 100 in the developer mode when the developer mode value is one.

In normal mode, the boot stub 224 may verify that firmware (e.g., the writable firmware 260) is digitally signed by a trusted supplier (e.g., manufacturer of the computing device) and only allow the processor 110 to execute the firmware after verifying that the firmware is digitally signed by the trusted supplier. For example, the firmware may be digitally signed by the trusted supplier using a private key and the boot stub 224 may use a corresponding public key stored in the write-protected partition 220 to verify the digitally-signed firmware.

Similarly, the writeable firmware 260 or other firmware may only allow the processor 110 to run an OS (e.g., from the internal storage device 130 or the external memory device 167) after verifying that the OS is digitally signed by a trusted supplier. For example, the OS may be digitally signed by the trusted supplier using a private key and the boot stub 224 or other firmware may use a corresponding public key stored in the write-protected partition 220 to verify the digitally-signed OS.

Thus, the boot stub 224 and/or firmware may perform a verify boot process in the normal mode to verify that the processor 110 executes code that is digitally signed by a trusted supplier. The verify boot process provides a normal user with a high level of security when the computing device is operated in normal mode.

In the developer mode, the boot stub 224 may allow the processor 110 to execute firmware that is unsigned and/or user signed. Similarly, the writable firmware 260 and/or other firmware may allow the processor 110 to run an OS that is unsigned and/or user signed. To do this, the developer mode may disable all or a portion of the verify boot process performed in the normal mode. The developer mode allows a developer to build and run its own code on the computer 100, which may not be possible in the normal mode.

In one aspect, a developer may enabled the developer mode when the computer is powered on or booting. In this aspect, the developer may enable the developer mode by holding down one or more developer keys on the keyboard 135. The one or more developer keys may comprise a single key or a combination of two or more keys on the keyboard 135. Any key on the keyboard 135 may be assigned as a developer key. For example, the ‘D’ key may be assigned as a developer key during boot time and may be used normally to enter the letter ‘D” (e.g., into a text box or document) at runtime.

In another example, a combination of pre-existing keys (e.g., Esc and Mute keys) on the keyboard 135 may be assigned as developer keys during boot and may be used normally after boot. In this example, the developer may enable the developer mode by simultaneously holding down the combination of keys for a period of time during boot time. An advantage of assigning a combination of keys as the developer keys is that a normal user is less likely to unintentionally press the combination of keys.

In this aspect, during the boot process, the boot stub 224 and/or other firmware may check the keyboard state to determine whether the developer key(s) are held down. If the developer key(s) are held down and the developer mode is not already enabled, then the boot stub 224 and/or other firmware may enable the developer mode by setting the developer mode value in the secure memory device 150 to one. The boot stub 224 and/or other firmware may require that the developer key(s) be held down for a period of time (e.g., 30 seconds) before enabling the developer mode. If the developer key(s) are not held down and the developer mode is not already enabled, then the boot stub 224 and/or other firmware may leave the developer mode value of zero alone and lock the developer mode value in the lockable memory space 155, as discussed further below. If the developer mode is already enabled, then the boot stub 224 and/or other firmware may leave the developer mode value of one alone.

Thus, various aspects of the subject technology provide keyboard-controlled developer mode, in which a developer may enable the developer mode by holding down a specific key or combination of keys on the keyboard 135 at power on or while the computer is booting. This advantageously eliminates the need of having to provide a separate physical switch to enable the developer mode.

As discussed above, when operating in the developer mode, the computer 100 may be more susceptible to security attacks since the computer 100 may execute unverified code. For example, an attacker may place the computer 100 in the developer mode in order to install malicious code (e.g., keystroke logger to obtain personal information typed into the computer by the user). Therefore, it is desirable to prevent an attacker from enabling the developer mode.

In one aspect, at the start of a boot process, the lockable memory space 155 may be unlocked. While the lockable memory space 155 is unlocked, the boot stub 224 and/or other firmware may write to the lockable memory space 155 to enable or disable the developer mode. For example, the boot stub 224 and/or other firmware may set the developer mode value to one to enable the developer mode when a developer holds down the developer key(s).

Before the end of the boot process, the boot stub 224 and/or other firmware may lock the lockable memory space 155 until the next boot cycle. The boot stub 224 and/or other firmware may do this by issuing a command to the secure memory device 150 to lock the lockable memory space 155 until the next boot cycle. Once the lockable memory space 155 is locked, the developer mode value may remain locked until the computer 100 is rebooted. As a result, if the developer mode value is zero (indicating that the developer mode is disabled), then the developer mode value of zero is locked until the computer 100 is rebooted. This prevents an attacker from setting the developer mode value to one to enable the developer mode.

Thus, at the start of each boot cycle, the secure memory device 150 may unlock the lockable memory space 155, allowing the boot stub 224 and/or other firmware to set the developer mode value during the boot cycle. Before the end of the current boot cycle, the boot stub 224 and/or other firmware may issue a command to the secure memory device 150 to lock the lockable memory space 155 until the next boot cycle. As a result, only the boot stub 224 and/or other firmware may have the ability to set the developer mode value to one during a boot cycle, preventing malicious code from setting the developer mode value to one at runtime to enable the developer mode.

In one aspect, the developer mode value may still be readable when the lockable memory space 155 is locked, but not writable. This allows a program (e.g., writable firmware 226 and/or an OS) to read the developer mode value after the lockable memory space 155 is locked to determine whether the developer mode is enabled, but not to change the developer mode value.

In another aspect, the secure memory device 150 may allow a program to set the developer mode value from one to zero even when the lockable memory space 155 is locked, but not to set the developer mode value from zero to one. Thus, the secure memory device 150 according to this aspect allows a program to disable the developer mode when the lockable memory space 155 is locked, but not to enable the developer mode.

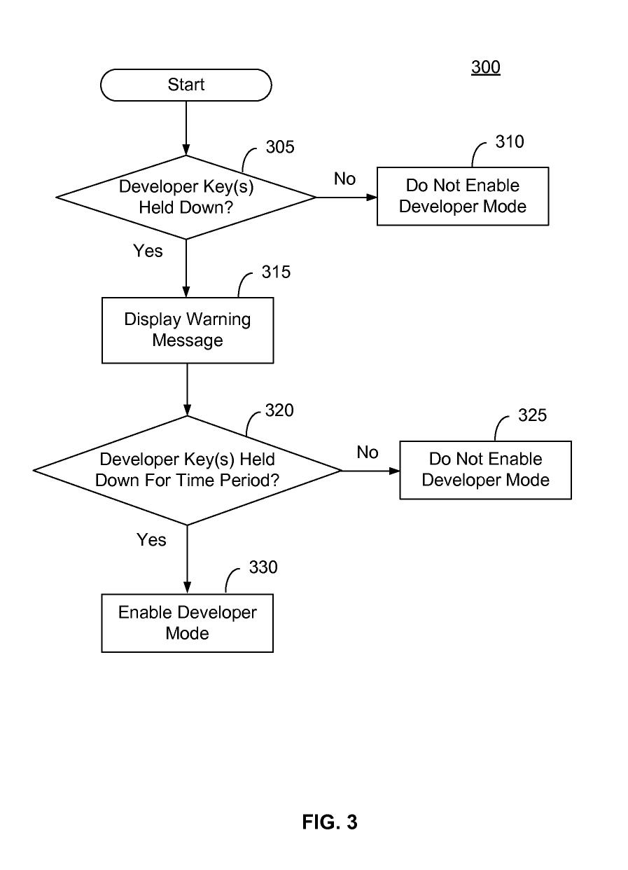

FIG. 3 shows a process 300 for enabling the developer mode on the computer 100 according to an aspect of the subject technology. The process 300 may be performed by the boot stub 224 and/or other firmware during a boot cycle.

In step 305, a determination is made whether the developer key(s) on the keyboard 135 are held down. As discussed above, the developer key(s) may comprise a single key or a combination of two or more keys on the keyboard 135.

If the developer key(s) are not held down in step 305, then the developer mode is not enabled in step 310. In this case, the lockable memory space 155 storing the developer mode value in the secure memory device 150 may be locked until the next boot cycle.

If the developer key(s) are held down in step 305, then the process proceeds to step 315. In step 315, a warning message may be displayed to the user on the display 140. The warning message may warn the user that the developer mode is about to be enabled and/or that verified boot is about to be disabled. The warning message may be accompanied by an audio warning (e.g., beep) from the audio device 145.

In step 320, a determination is made whether the developer key(s) are held down for a period of time (e.g., 30 seconds). If the developer key(s) are not held down for the period of time, then the developer mode is not enabled in step 325. In this case, the lockable memory space 155 storing the developer mode value may be locked until the next boot cycle to prevent an attacker from enabling the developer mode, as explained above.

If the developer key(s) are held down for the period of time (e.g., 30 seconds), then the developer mode is enabled in step 330. In this case, the developer mode value in the lockable memory space 155 may be set to one to enable the developer mode. In addition, the light indicator 160 may be activated to alert the user that the computer 100 is operating in the developer mode. The indicator 160 may remain on as long as the developer mode value is one.

In one aspect, instead of having the user hold down the developer key(s) for a period of time to enable the developer mode, the user may be allocated a time period (e.g., 30 seconds) after pressing down the developer key(s) in which to abort enablement of the developer mode. For example, after the user presses down the developer key(s), a warning message may be displayed indicating the developer mode will be enabled unless the user aborts the operation within the time period. The user may abort the operation by pressing one or more keys on the keyboard 135 within the time period. Otherwise, the developer mode may be enabled. Thus, if the user does not intend to enable the developer mode, then the user can prevent the developer mode from being enabled by pressing the one or more keys within the time period. In this example, the warning message may include instructions instructing the user which key or keys to press to abort enablement of the developer mode and/or a timer indicating how much time the user has left to abort enablement of the developer mode.

As discussed above, the developer mode value in the lockable memory space 155 may persist across power cycles. Thus, when the developer mode value is set to one to enable the developer mode in step 330, the developer mode value remains one until the developer mode value is set to zero. As a result, once the developer mode is enabled, the user does not have to re-enable the developer mode each time the computer 100 is booted.

In this aspect, a developer mode warning message may appear each time the computer 100 is booted to alert the user that the computer 100 is operating in the developer mode. The warning message may be displayed for a certain time period (e.g., 30 seconds) and may be accompanied by an audio warning (e.g., beep) from the audio device 145. The user may have the option of bypassing or timing out the warning message to immediately continue booting the computer 100 in the developer mode by pressing one or more keys (e.g., Ctrl+D) on the keyboard 135. The user may also have the option of booting the computer 100 from firmware and/or an OS stored in the external memory device 167 by pressing one or more keys (e.g., Ctrl+U).

In one aspect, the developer mode warning message may include instructions for disabling the developer mode in case the user desires to disable the developer mode. For example, the user may press one or more keys (e.g., space bar) during the warning message to disable the developer mode.

When the user disables the developer mode, the boot stub 224 and/or other firmware may set the developer mode value from one to zero to return the computer 100 to the normal mode and lock the lockable memory space 155. If the computer 100 still holds a copy of writable firmware 260 signed by a trusted supplier and/or a copy of an OS signed by a trusted supplier, then the boot stub 224 and/or other firmware may verify the writable firmware 260 and/or the OS. After verifying the writable firmware 260 and/or OS, the boot stub 224 and/or other firmware may boot the computer 100 using the writable firmware 260 and/or OS.

However, if the computer 100 no longer holds a copy of writable firmware 260 signed by a trusted supplier and/or a copy of an OS signed by a trusted supplier, then the computer 100 may not properly boot in the normal mode. In this case, the boot stub 224 or other firmware may initiate a recovery process to boot the computer 100, as discussed further below.

In one aspect, the recovery process may set the developer mode value from one to zero and lock the lockable memory space 155. In addition, the recovery process may boot the computer 100 using firmware signed by a trusted supplier from the external memory device 167 or other memory. Similarly, the recovery process may boot the computer using an OS signed by a trusted supplier from the external memory device 167 or other memory. After booting the computer 100, a copy of the firmware and/or OS may be written to the non-volatile memory 115 and/or the internal storage device 130, respectively, so that the computer 100 can boot in the normal mode in subsequent boots.

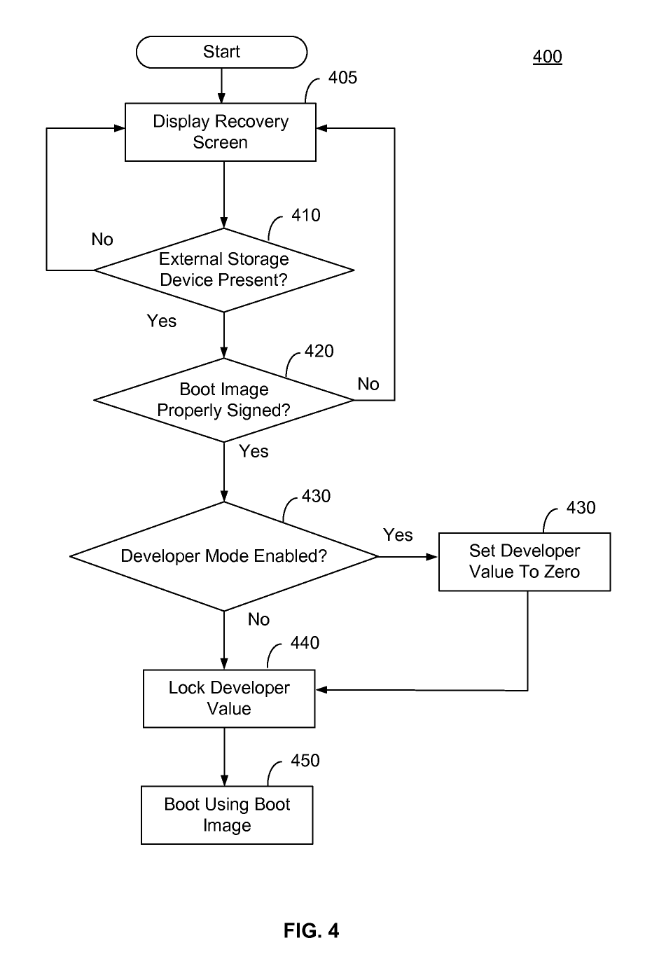

FIG. 4 shows a recovery process 400 according to an aspect of the subject technology. The recovery process 400 may be performed the recovery firmware 226, and/or other firmware during a boot process.

In step 405, a recovery screen is displayed on the display 140. The recovery screen may prompt the user to insert an external storage device 167 with a recovery boot image into the computer 100. The boot image may include firmware signed by a trusted supplier (e.g., computer manufacturer) and/or an OS signed by a trusted supplier.

In step 410, a determination is made whether the external storage device 167 is present. For example, when the external storage device 167 is coupled to the computer 100, the external device interference 165 may detect the presence of the external storage device 167 and inform the processor of the detected presence of the external storage device 167. If the external storage device 167 is not present, then the process continues to display the recovery screen in step 405. Otherwise, the process may proceed to step 420.

In step 420, a determination is made whether the boot image in the external storage device 167 is properly signed by a trusted supplier. For example, the boot image may be digitally signed with a private key and the digitally-signed boot image may be verified using a corresponding public key, which may be stored in the write-protected partition 220 of the non-volatile memory 115 or other memory.

If the boot image is not properly signed, then the process may continue to display the recovery screen in step 405. In this case, the recovery screen may indicate to the user that the external storage device 167 does not have a properly signed boot image to recover the computer 100. If the image is properly signed, then the process proceeds to step 430.

In step 430, a determination is made whether the developer mode is enabled on the computer 100. This may be done by checking whether the developer mode value in the lockable memory space 155 is one or zero. If the developer mode is enabled, then the developer mode value is set to zero to disable the developer mode and place the computer 100 in the normal mode. Thus, if the developer mode is enabled, then the recovery process may automatically disable the developer mode so that the user does not need to take additional action to disable the developer mode. After setting the developer mode value to zero, the process proceeds to step 440. If the developer mode is not enabled, then the process proceeds directly to step 440.

In step 440, the developer mode value is locked. This may be done by issuing a command to the secure memory device 150 to lock the lockable memory space 155 storing the developer mode value. Once locked, the lockable memory space may remain locked until the next boot cycle.

In step 450, the computer 100 is booted using the boot image from the external storage device 167. After booting the computer 100, the boot image may be written to the non-volatile memory 115 and/or the internal storage device 130. On the next boot cycle, the computer 100 can boot using the copy of the boot image in the non-volatile memory 115 and/or the internal storage device 130.

The user may initiate the recovery process in FIG. 4 when the computer 100 is powered on or while the computing is booting by pressing one or more recovery keys on the keyboard 135. For example, the user may initiate the recovery process when the user desires to switch the computer from the developer mode to the normal mode and recover the computer 100. The user may also initiate the recovery process when the computer 100 is corrupted.

The one or more recovery keys may comprise a single key or a combination of two or more keys on the keyboard 135. Any key on the keyboard 135 may be assigned as a recovery key. For example, the ‘R’ key may be assigned as a recovery key during boot and used normally after boot. In another example, a combination of pre-existing keys (e.g., Refresh and Power keys) on the keyboard 135 may be assigned as recovery keys during boot. In this example, the user may initiate the recovery process by simultaneously holding down the combination of keys for a period of time.

Alternatively, the user may initiate the recovery process when the computer 100 displays the developer mode warning message during boot time. In this aspect, the developer mode warning message may give the user the option of disabling the developer mode by initiating the recovery process, for example, by pressing one or more keys (e.g., space bar) on the keyboard 135 as instructed to by the warning message.

In one aspect, if the boot image in the external memory device 167 is not properly signed in step 420 (e.g., unsigned or user-signed firmware and/or OS) and the developer mode is enabled, then the computer 100 may be booted using the boot image from the external memory device 167 in the developer mode. In this case, the developer mode value is left at a value of one. Thus, when the recovery screen is displayed in step 405 and the developer mode is enabled, the user may have the option of booting the computer using an unsigned or user-signed boot image instead of completing the recovery process.

In one aspect, the user may enable developer mode when the recovery screen is displayed in step 405 instead of completing the recovery process. For example, when the recovery screen is displayed, the user may hold down the developer key(s) instead of inserting an external storage device 167 with a properly-signed boot image. In this case, the processor 110 may perform the process in FIG. 3 to enable the developer mode. The user may then insert an external memory device 167 with an unsigned or user-signed boot image into the computer 100 to boot the computer 100 in the developer mode using the unsigned or user-signed boot image. Thus, when the recovery screen is displayed in step 405, the user may have the option of enabling the developer mode instead of completing the recovery process (e.g., by holding down the developer key(s) when the recovery screen is displayed). As discussed above, the user may bring up the recovery screen by pressing one or more recovery key(s) on the keyboard 135 during power on or while the computer is booting.

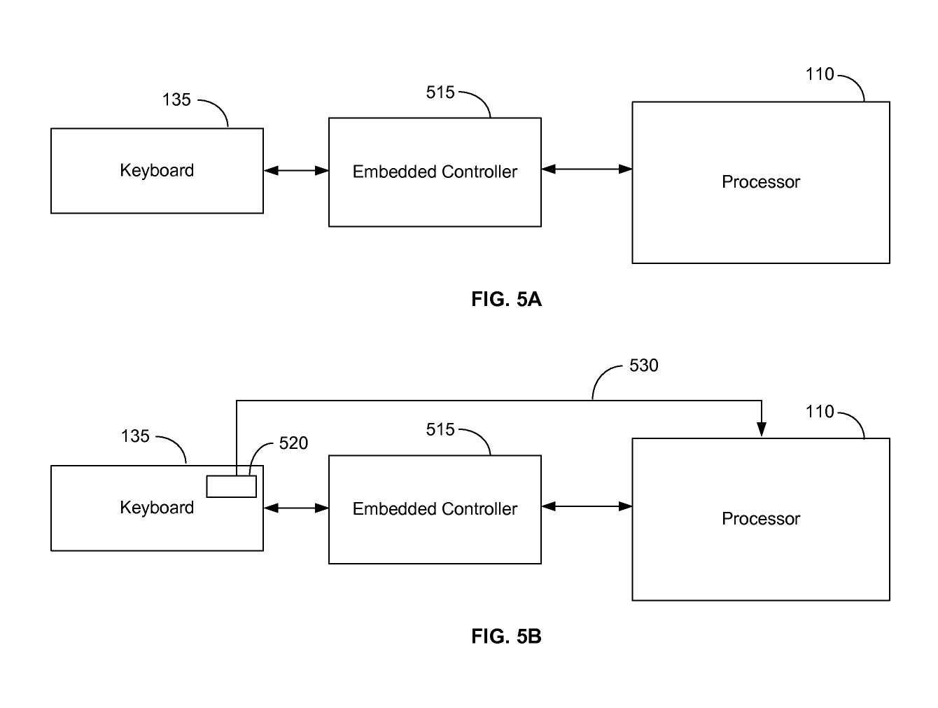

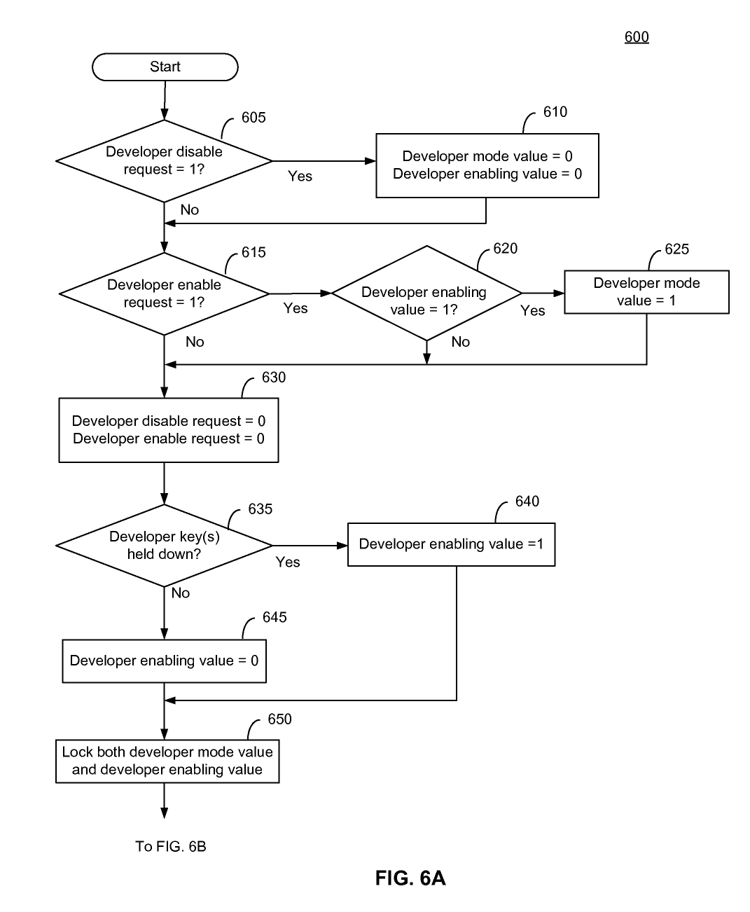

In one aspect, the processor 110 may interface with the keyboard 135 through an embedded controller (EC) 515 according to one aspect of the subject technology, an example of which is shown in FIG. 5A. The embedded controller 515 may include a processor and a memory storing firmware that is executed by the processor to perform the operations of the embedded controller 515 described herein.

In one aspect, the embedded controller 515 may receive a keyboard matrix signal from the keyboard 135 specifying the position (e.g., row and column) of a key pressed on the keyboard 135. The embedded controller 515 may then identify the key based on the position of the key on the keyboard (e.g., using a keyboard layout stored in local memory) and send the identity of the key to the processor 110. Therefore, in this aspect, the processor 110 receives keyboard information from the embedded controller 515 identifying which key is pressed on the keyboard 135.

In one aspect, the firmware of the embedded controller 515 may be stored in read-only memory, which prevents the firmware from being altered by malicious code. As a result, the processor 110 may trust that the keyboard information received from the embedded controller 515 accurately reflects the keyboard state. For example, if the keyboard information from the embedded controller 515 indicates that the recover key(s) are pressed on the keyboard 135, then the processor 110 may initiate the recovery process. Similarly, if the keyboard information from the embedded controller 515 indicates that the developer key(s) are pressed on the keyboard, then the processor 110 may enable the developer mode.

In another aspect, the firmware of the embedded controller 515 may be stored in writable memory (e.g., EEPROM). In this case, an attacker may install malicious code in the writable memory. For example, the malicious code may direct the processor of the embedded controller 515 to send false keyboard information to the processor 110 indicating the developer key(s) are pressed when the developer key(s) are not actually being pressed by the user. This way, the malicious code may enable the developer mode to disable security features associated with the normal mode and hack into the computer 100.

To address this, the keyboard 135 may include a developer module 520 that is coupled to the processor 110 via a communication link 530 (e.g., dedicated GPIO lines) that bypasses the embedded controller 515, as shown in FIG. 5B. The developer module 520 may be configured to determine when the developer key(s) are pressed on the keyboard and send a developer signal to the processor 110 via the communication link 530 when the developer key(s) are pressed. To do this, the developer module 520 may be coupled to the developer key(s) on the keyboard to sense when the developer key(s) are pressed, and send the developer signal when the developer key(s) are pressed. In this aspect, the developer module 520 may comprise logic (e.g., hard-wired logic) that cannot be altered by malicious code, and the processor 110 may enable the developer mode when it receives the developer signal from the developer module 520 via the communication link 530.

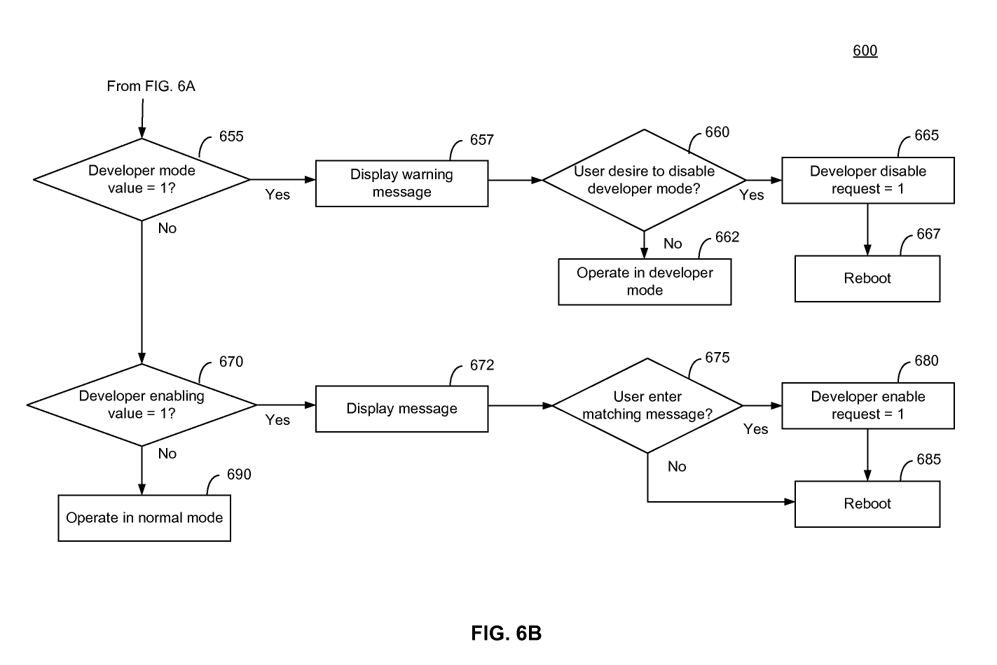

FIGS. 6A and 6B show a process 600 for controlling the developer mode on the computer 100 according to an aspect of the subject technology. The process 600 may be performed by the boot stub 224 and/or other firmware when executed by the processor 110.

In this aspect, a developer enabling value may be stored in the lockable memory space 155 in addition to the developer mode value. The developer enabling value may be used to indicate the user's intent to enable the developer mode, as discussed further below.

Also, a developer disable request flag and a developer enable request flag may be stored in the non-volatile memory 115 and/or other memory of the computer 100. The developer disable request flag may be set to one to request that the developer mode be disabled in a next boot cycle and the developer enable request flag may be set to one to request that the developer mode be enabled in a next boot cycle.

Referring to FIG. 6A, the process 600 may be performed at boot time. In one aspect, the boot stub 224 may first check whether recovery has been initiated. If recovery has been initiated, then the boot stub 224 may load the recovery firmware 226 to recover the computer 100. If recovery has not been initiated, then the boot stub 224 may begin performing the process 600.

In step 605, a determination is made whether the developer disable request flag equals one. As discussed further below, the developer disable request flag may have been set to one during a previous boot cycle when the user communicated a desire to disable the developer mode.

If the developer disable request flag is equal to zero, then the process proceeds to step 615. If the developer disable request flag is equal to one, then the developer mode value and the developer enabling value are both set to zero in step 610, after which the process proceeds to step 615. In the present disclosure, it is to be understood that setting a value to zero includes leaving the value alone if the value is already zero.

In step 615, a determination is made whether the developer enable request flag equals one. As discussed further below, the developer enable request flag may have been set to one during a previous boot cycle when the user communicated a desire to enable the developer mode.

If the developer enable request flag is equal to zero, then the process proceeds to step 630. If the developer enable request flag is equal to one, then the process proceeds to step 620. In step 620, a determination is made whether the developer enabling value is equal to one. If the developer enabling value is equal to zero, then the process proceeds to step 630. If the developer enabling value is equal to one, then the developer mode value is set to one in step 625, thereby enabling the developer mode. As discussed below, the developer enabling value is equal to one when the user held down the developer key(s) during a previous boot cycle. After setting the developer mode value to one in step 625, the process proceeds to step 630.

In step 630, both the developer disable request flag and the developer enable request flag are set to zero (i.e., cleared).

In step 635, a determination is made whether the developer key(s) are held down by the user. As discussed above, the user may hold down the developer key(s) during boot when the user desires to enable the developer mode. If the developer key(s) are not held down, then the developer enabling value is set to zero in step 645.

If the developer key(s) are held down, then the developer enabling value is set to one in step 640. As discussed further below, a developer enabling value of one may be a requirement for enabling the developer mode during the next boot cycle. Step 635 may require that the developer key(s) be held down for a certain time period in order to be satisfied.

In step 650, both the developer mode value and the developer enabling value are locked in the lockable memory space 155 until the next boot cycle. This prevents the values from being changed until the next boot cycle.

Referring to FIG. 6B, in step 655, a determination is made whether the developer mode value is equal to one. If the developer mode value is equal to zero, then the process proceeds to step 670. If the developer mode value is equal to one, then the process proceeds to step 657.

In step 657, a warning message is displayed to the user warning the user that the developer mode is enabled. The warning message may be accompanied by an audio warning (e.g., a beep).

In step 660, a determination is made whether the user desires to disable developer mode after viewing the warning message. For example, the user may communicate a desire to disable developer mode by pressing one or more keys (e.g., space bar, Enter key, Esc key, etc.) on the keyboard 135. If the user does not communicate a desire to disable the developer mode, then the computer 100 operates in the developer mode in step 662. This may include loading unverified, unsigned or user-signed code (e.g., firmware and/or OS).

If the user communicates a desire to disable the developer mode, then the developer disable request flag is set to one in step 665 and the computer 100 is rebooted in step 667. When the computer is rebooted, the process 600 returns to step 605 for the next boot cycle. Since the developer disable request flag is equal to one, the developer mode value is set to zero in step 610 during the next boot cycle, thereby disabling the developer mode.

In step 670, a determination is made whether the developer enabling value is equal to one. If the developer enabling value is equal to zero, then the computer 100 is operated in the normal mode in step 690. This may include verifying that code (e.g., firmware and/or OS) is digitally-signed by a trusted third party and loading the code upon successful verification.

If the developer enabling value is equal to one, then the process proceeds to step 672. As discussed above, the developer enabling value equals one if the user held down the developer key(s) in step 635 during the current boot cycle.

In step 672, a message is displayed to the user on the display 140. After viewing the message, the user may enter the message into the computer 100 via the keyboard 135 or other input device.

In step 675, a determination is made whether the user entered a message matching the message displayed to the user. If the user entered a message that does not match the displayed message or no message is entered by the user within a time period, then the computer 100 is rebooted in step 685. In this case, the developer enable request flag is equal to zero since the developer enable request flag was cleared in step 630. As a result, the developer mode is not enabled during the next boot cycle.

If the user entered a message matching the displayed message, then the developer enable request flag is set to one in step 680 and the computer 100 is rebooted in step 685. In this case, since the developer enable request flag and the developer enabling value are both equal to one, the developer mode is enabled in step 625 during the next boot cycle.

In one aspect, the message displayed to the user in step 672 may be a one time password (OTP) that is only valid one time and changes each time the developer enabling value is set to one. The OTP may comprise a random number (e.g., a random eight-digit number) that is generated by a random number generator. The random number generator may be implemented in software and/or hardware. Requiring the user to enter the OTP to enable the developer mode prevents an attacker from enabling the developer mode. This is because malicious code in the embedded controller 515 cannot view the OTP on the display 140. As a result, the malicious code cannot simulate keystrokes corresponding to the OTP, and therefore cannot enter the correct OTP to enable the developer mode.

In one aspect, the process 600 may be performed by the boot stub 224 and rewritable firmware 260. For example, the boot stub 224 may perform steps 605 through 650. After performing step 650, the boot stub 224 may load the rewritable firmware 260 to perform the rest of the process 600. In this example, the boot stub 224 may verify that the rewritable firmware 260 is digitally-signed by a trusted before allowing the rewritable firmware 260 to perform the rest of the process 600. The rewritable firmware 260 may be updated after the computer 100 is shipped from the manufacturer. In this aspect, the processor 110 may execute unverified, unsigned and/or user-signed OS (e.g., kernel) in the developer mode.

Because the boot stub 224 locks the developer mode value and the developer enabling value in step 650 before handing control to the rewritable firmware 260, the rewritable firmware 260 is not able to change these values on its own. This prevents malicious code from overwriting the rewritable firmware and setting these values to one to enable the developer mode.

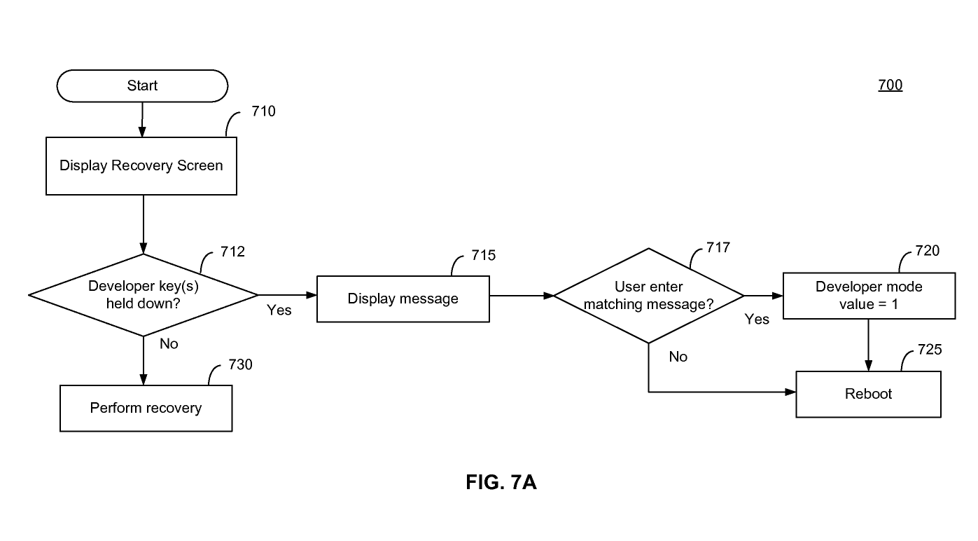

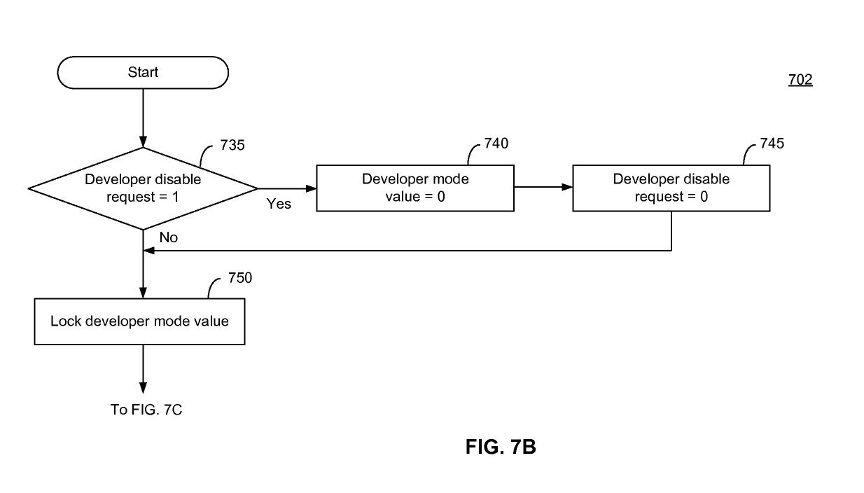

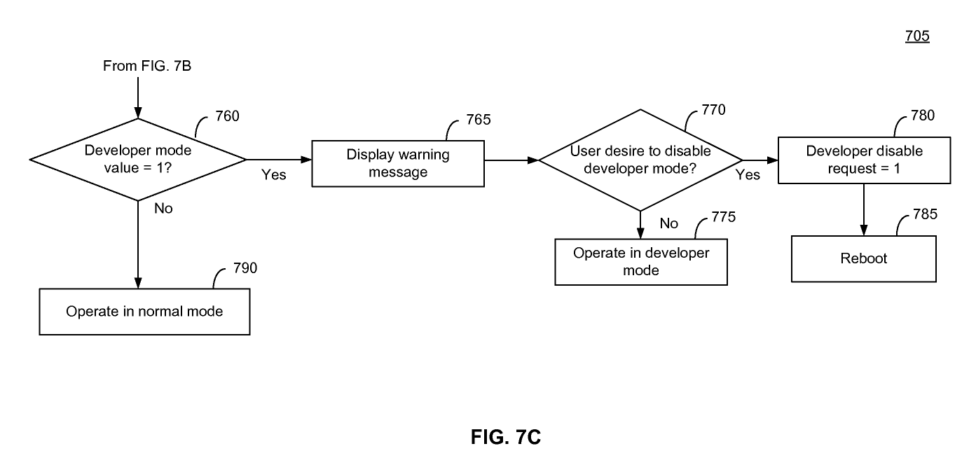

FIGS. 7A-7C show various processes for controlling the developer mode on the computer 100 according to various aspects of the subject technology. More particularly, FIG. 7A shows a process 700 for enabling developer mode, which may be performed by the recovery firmware 226. FIG. 7B shows a process 702 for disabling developer mode, which may be performed by the boot stub 224. FIG. 7C shows a process 705 for requesting that the developer mode be disabled, which may be performed by the rewritable firmware 260.

Referring to FIG. 7A, process 700 may be performed by the recovery firmware 226 when recovery is initiated during boot time. For example, recovery may be initiated when the user presses one or more recovery key(s) on the keyboard 135 during power on or while the computer is booting.

In step 710, a recovery screen is displayed on the display 140. The recovery screen may prompt the user to insert an external storage device 167 with a recovery boot image into the computer 100.

In step 712, a determination is made whether the developer key(s) are held down by the user. If the developer key(s) are not held down, then the process may proceed to step 730 and perform a recovery of the computer 100, in which a recovery boot image is loaded (e.g., from the external storage device 167). For example, the computer 100 may be recovered by performing the recovery process shown in FIG. 4.

If the developer key(s) are held down, then a message is displayed to the user in step 715. The message may be a OTP, as discussed above. After viewing the message, the user may enter the message into the computer 100 via the keyboard or other input device.

In step 717, a determination is made whether the user entered a message matching the message displayed to the user. If the user entered a message that does not match the displayed message or no message is entered by the user within a time period, then the computer 100 is rebooted in step 725.

If the user entered a message matching the displayed message, then the developer mode value is set to one in step 720, thereby enabling the developer mode. The computer 100 is then rebooted in the developer mode in step 725.

Thus, when the recovery screen is displayed, the user has the option of enabling developer mode by holding down the developer key(s) instead of continuing with recovery.

In this aspect, the secure memory device 155 may remain unlocked when the recovery firmware 226 is executed since the recovery firmware 226 is write-protected. This allows the recovery firmware to enable developer mode directly in step 720 without having to set a developer enable request flag and reboot the computer 100 to enable developer mode.

Referring to FIG. 7B, process 702 may be performed by the boot stub 224 at boot time. In one aspect, the boot stub 224 may first check whether recovery has been initiated. If recovery has been initiated, then the boot stub 224 may load the recovery firmware 226 to perform process 700. If recovery has not been initiated, then the boot stub 224 may begin performing process 702.

In step 735, a determination is made whether the developer disable request flag is equal to one. As discussed further below, the developer disable request flag may have been set to one during a previous boot cycle when the user communicated a desire to disable the developer mode.

If the developer disable request flag is equal to zero, then the process proceeds to step 750. If the developer disable request flag is equal to one, then the developer mode value is set to zero to disable the developer mode in step 740. The developer disable request flag is then set to zero (i.e., cleared) in step 745, and the process proceeds to step 750.

In step 750, the developer mode value is locked in the lockable memory space 155. After the developer mode value is locked, the boot stub 224 may load the rewritable firmware 226 to perform process 705 shown in FIG. 7C. Locking the developer mode value before handing control to the rewritable firmware 226 ensures that only write-protected firmware can set the developer mode value to one. This prevents an attacker from installing malicious code to set the developer mode value to one at runtime to enable the developer mode.

Referring to FIG. 7C, process 705 may be performed by the rewritable firmware 226.

In step 760, a determination is made whether the developer mode value is equal to one. If the developer mode value is equal to zero, then the computer 100 is operated in the normal mode in step 790. This may include verifying that code (e.g., firmware and/or OS) is digitally-signed by a trusted third party and loading the code upon successful verification.

In step 765, a warning message is displayed to the user warning the user that the developer mode is enabled. The warning message may be accompanied by an audio warning (e.g., a beep).

In step 770, a determination is made whether the user desires to disable developer mode after viewing the warning message. For example, the user may communicate a desire to disable developer mode by pressing one or more keys (e.g., space bar, Enter key, Esc key, etc.) on the keyboard 135. If the user does not communicate a desire to disable the developer mode, then the computer 100 operates in the developer mode in step 775. This may include loading unverified, unsigned or user-signed code (e.g., firmware and/or OS).

If the user communicates a desire to disable the developer mode, then the developer disable request flag is set to one in step 780 and the computer 100 is rebooted in step 785. When the computer is rebooted, the boot stub 224 may perform process 702 for the next boot cycle. Since the developer disable request flag is equal to one, the developer mode value is set to zero in step 740 during the next boot cycle, thereby disabling the developer mode. If the computer 100 still has a copy of an official OS signed by a trusted supplier, then the computer 100 may boot in normal mode using the official OS without having to go into recovery mode to load a recovery boot image.

During manufacturing of the computer 100, it may be desirable to enable developer mode. For example, developer mode allows the manufacturer to run test code on the computer 100 without having to digitally sign the test code.

In one aspect, a developer mode override value may be stored in the write-protected partition 220 of the non-volatile memory 115. The developer mode override value may be set to one to enable developer mode and zero to disable developer mode. As discussed above, the write-protected partition 220 may be writable during manufacturing. This allows the developer mode override value to be set during manufacturing to enable developer mode.

In this aspect, the boot stub 224 and/or other firmware may check the developer mode override value during boot. If the developer mode override value is equal to one, then the boot stub 224 and/or other firmware may operate in developer mode regardless of the state of the developer mode value in the secure memory device 150.

The developer mode override value may provide one or more of the following advantages. A program can easily set the developer mode override value to one during manufacturing to enable developer mode without requiring that a user hold down the developer key(s) and/or enter a message during boot. This is because the developer mode override value may reside in the write-protected partition 220 of the non-volatile memory, which may be writable during manufacturing. Also, the developer mode override value allows the developer mode to be enabled before the secure memory device 150 is installed and/or initialized during manufacturing.

Before the computer 100 is shipped from the manufacturer, the developer mode override value may be cleared to disable developer mode and the write-enable pin 240 or write protection may be set to lock the write-protection partition 220 of the non-volatile memory 115. At this point, the processor 110 is prevented from writing to the write-protection partition 220 (i.e., the write-protection partition 220 becomes read-only). Thus, the developer mode override value may only be used to enable developer mode during manufacturing.

In one aspect, when the developer mode is enabled by the developer mode override value, the developer mode warning screen may be shortened or eliminated. This is because the manufacturer is aware when the computer 100 is in developer mode and may desire to speed up factory flow by not having to wait for the developer mode warning screen to time out.

Many of the above-described features and applications may be implemented as a set of machine-readable instructions stored on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this disclosure, the term “software” and “program” is meant to include firmware or applications stored in a memory, which can be executed by a processor. Also, in some implementations, multiple software aspects can be implemented as sub-parts of a larger program while remaining distinct software aspects. In some implementations, multiple software aspects can also be implemented as separate programs. Finally, any combination of separate programs that together implement a software aspect described here is within the scope of the disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computers and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for controlling a developer mode of a computer, the method comprising:
during boot time of the computer, determining whether a set of one or more keys on a keyboard corresponding to the developer mode are held down; and
if the set of one or more keys are held down, then setting a developer mode value within a lockable memory space to enable the developer mode, and setting a developer enabling value within the lockable memory space to enable the developer mode during a next boot cycle.

2. The method of claim 1, further comprising turning on a light indicator when the developer mode is enabled.

3. The method of claim 1, further comprising locking the lockable memory space until the computer is rebooted.

4. (canceled)

5. The method of claim 1, further comprising, if the developer mode is enabled, then displaying a warning message during a next boot cycle of the computer indicating that the developer mode is enabled.

6. The method of claim 5, further comprising:
during the next boot cycle, determining whether one or more keys on the keyboard corresponding to disabling the developer mode are held down; and
if the one or more keys corresponding to disabling the developer mode are held down, then performing the steps of:
setting the developer mode value within the lockable memory space to disable the developer mode; and
locking the lockable memory space until the computer is rebooted.

7. A non-transitory machine-readable medium comprising: instructions stored therein, which when executed by a machine, cause the machine to perform operations for controlling a developer mode of a computer, the operations comprising:
during boot time of the computer:
clearing a developer enable request value;
determining whether a combination of keys on a keyboard corresponding to the developer mode are held down; and
if the combination of keys are held down, then setting a developer mode value within a lockable memory space to enable the developer mode, and setting a developer enabling value within the lockable memory space to enable the developer mode during a next boot cycle.

8. The non-transitory machine-readable medium of claim 7, whereinthe operations further comprise locking the lockable memory space until the computer is rebooted.

9. The non-transitory machine-readable medium of claim 7, wherein each of the keys in the combination of keys performs a function at runtime that is different from a function in developer mode.

10. The non-transitory machine-readable medium of claim 7, wherein determining whether the combination of keys are held down comprises determining whether the combination of keys are held down for a period of time.

11. The non-transitory machine-readable medium of claim 10, wherein the operations further comprise displaying a warning message during the period of time.

12. The non-transitory machine-readable medium of claim 7, wherein determining whether the combination of keys are held down comprises determining whether the combination of keys are held down simultaneously.

13. The non-transitory machine-readable medium of claim 7, wherein the operations further comprise, if the developer mode is enabled, then displaying a warning message on a next boot cycle of the computer indicating that the developer mode is enabled.

14. A system for controlling a developer mode of a computer, comprising:
one or more processors; and
a machine-readable medium comprising instructions stored therein, which when executed by the one or more processors, cause the one or more processors to perform operations comprising:
during boot time of the computer:
clearing a developer disable request value;
determining whether a set of one or more keys on a keyboard corresponding to the developer mode are held down;
if the set of one or more keys are held down, then setting a developer mode value within a lockable memory space to enable the developer mode, and setting a developer enabling value within the lockable memory space to enable the developer mode during a next boot cycle; and
locking the lockable memory space until the computer is rebooted.

15. (canceled)

16. The system of claim 14, wherein the operations comprise, if the developer mode is enabled, then displaying a warning message during a next boot cycle of the computer indicating that the developer mode is enabled.

17. A computer-implemented method for controlling a developer mode of a computer, the method comprising:
during boot time of the computer, determining whether a set of one or more keys on a keyboard corresponding to the developer mode are held down; and
if the set of one or more keys are held down, then performing the steps of:
displaying a message;
receiving a message entered into the computer by a user;
determining whether the received message matches the displayed message; and
if the received message matches the displayed message, then setting a developer mode value within a lockable memory space to enable the developer mode, and setting a developer enabling value within the lockable memory space to enable the developer mode during a next boot cycle.

18. The method of claim 17, further comprising generating a one time password (OTP), wherein the displayed message comprises the OTP.

19. The method of claim 17, further comprising locking the lockable memory space until the computer is rebooted.

20. The method of claim 17, further comprising, if the developer mode is enabled, then displaying a warning message during a next boot cycle of the computer indicating that the developer mode is enabled.

21. The method of claim of 20, further comprising:
during the next boot cycle, determining whether one or more keys on the keyboard corresponding to disabling the developer mode are held down; and
if the one or more keys corresponding to disabling the developer mode are held down, then performing the steps of:
setting a request flag to request that the developer mode be disabled;
rebooting the computer to a subsequent boot cycle;
during the subsequent boot cycle and in response to the request, setting the developer mode value within the lockable memory space to disable the developer mode.

22. (canceled)

23. A non-transitory machine-readable medium comprising instructions stored therein, which when executed by a machine, cause the machine to perform operations for controlling a developer mode of a computer, the operations comprising:
during boot time of the computer, determining whether a set of one or more keys on a keyboard corresponding to the developer mode are held down; and
if the set of one or more keys are held down, then performing the steps of:
setting a request flag to request that the developer mode be enabled;
rebooting the computer to a next boot cycle;
during the next boot cycle and in response to the request, setting a developer mode value within a lockable memory space to enable the developer mode, and setting a developer enabling value within the lockable memory space to enable the developer mode during a next boot cycle.

24. The non-transitory machine-readable medium of claim 23, wherein the operations further comprise locking the lockable memory space before an end of the next boot cycle.

25. (canceled)

26. A computer-implemented method for recovering a computer, comprising:
determining whether a developer mode value within a lockable memory space is set to enable a developer mode, wherein a set of one or more keys on keyboard are configured to perform at least one function in the developer mode;
if the developer mode value is set to enable the developer mode, then setting the developer mode value within the lockable memory space to disable the develop mode, and setting a developer enabling value within the lockable memory space to enable the developer mode during a next boot cycle;
locking the lockable memory space; and
booting the computer using a boot image.

27. The method of claim 26, wherein further comprising verifying the boot image is digitally signed by a trusted supplier, wherein the computer is booted using the boot image if the boot image is verified.

28. The method of claim 26, further comprising reading the boot image from an external storage device coupled to the computer.

29. The method of claim 28, further comprising writing the boot image to a non-volatile memory of the computer.

30. The method of claim 29, further comprising, during a next boot cycle, booting the computer using the boot image in the non-volatile memory.

31. The method of claim 1, wherein the set of one or more keys on the keyboard perform at least one function at runtime that is different from enabling the developer mode.

32. The system of claim 14, wherein the set of one or more keys on the keyboard perform at least one function at runtime that is different from enabling the developer mode.

33. The non-transitory machine-readable medium of claim 23, wherein the set of one or more keys on the keyboard perform at least one function at runtime that is different from enabling the developer mode.
